(19) United States
(12) Patent Application Publication
(10) Pub. No.: US 2018/0254017 A1
(43) Pub. Date: Sep. 6, 2018

(54) ELECTRONIC FALSE NAIL DEVICE

(71) Applicant: Primax Electronics Ltd., Taipei (TW)

(72) Inventor: YU-MING LIN, Taipei (TW)

(21) Appl. No.: 15/655,260

(22) Filed: Jul. 20, 2017

(30) Foreign Application Priority Data
Mar. 3, 2017 (TW) 106107022

(51) Int. Cl. G09G 5/00; G09G 5/12; G02F 1/167

(52) U.S. Cl. CPC G09G 5/003; A45D 31/00; G02F 1/167; G09G 5/12

(57) ABSTRACT

An electronic false nail device includes an electronic ink false nail patch and a data transmission box. The electronic ink false nail patch includes a micro capsulation array layer and a circuit board. The micro capsulation array layer includes plural transparent shells, plural positively-charged first color particles and plural negatively-charged second color particles. These color particles are movable within the transparent shells. When the electronic ink false nail patch receives a signal from the data transmission box, plural positive electrodes and plural negative electrodes are generated by the circuit board. The positively-charged first color particles and the negatively-charged second color particles of each micro granule are moved to the corresponding positions according to the positive electrodes and the negative electrodes. Consequently, the micro capsulation array layer exhibits a predetermined pattern.

### FIELD OF THE INVENTION

The present invention relates to a false nail device, and more particularly to an electronic false nail device.

### BACKGROUND OF THE INVENTION

Loving beauty is the human nature. For example, some people stick false nails on their fingernails. Generally, various colors and various patterns are formed on the surfaces of the false nails. Consumers may choose their own styles of false nails. Nowadays, nail painters use traditional ink paints to draw patterns on the surfaces of the false nails. In other words, the painted false nails cannot be reused. If the consumer wants to change another type of false nail after the painted false nail has been attached on the fingernail for a certain time period, the consumer needs to purchase another false nail with a different painted pattern.

Recently, an electronic display sheet is introduced into the market. The electronic display sheet is used to display the pattern of the false nail. As known, it is necessary to connect the electronic display sheet with a power source in order to maintain the displayed pattern. However, if the electronic display sheet is disconnected from the power source, the pattern disappears. Consequently, the electronic display sheet is not suitably used as a wearable product for people.

### SUMMARY OF THE INVENTION

The present invention provides an electronic false nail device. When an electronic ink false nail patch is placed into a data transmission box, a signal is transmitted from the data transmission box to the electronic ink false nail patch. After a predetermined pattern is displayed on the electronic ink false nail patch, the electronic ink false nail patch can be removed from the data transmission box. Even if the electronic ink false nail patch is not connected with the power source, the predetermined pattern is still maintained on the electronic ink false nail patch. Consequently, the electronic ink false nail patch can be worn on the user's fingernail.

In accordance with an aspect of the present invention, there is provided an electronic false nail device. The electronic false nail device includes an electronic ink false nail patch and a data transmission box. The electronic ink false nail patch includes a micro capsulation array layer and a circuit board. The micro capsulation array layer includes a package structure and plural micro capsules within the package structure. Each of the micro capsules includes a transparent shell, plural positively-charged first color particles and plural negatively-charged second color particles. The plural positively-charged first color particles and the plural negatively-charged second color particles are accommodated within the transparent shell and movable within the transparent shell. The circuit board includes a transparent common electrode layer, a driving electrode layer and a first pin. The driving electrode layer includes plural electrodes. At least one electrode of the plural electrodes is located under one micro capsule of the plural micro capsules. Moreover, the plural positively-charged first color particles and the plural negatively-charged second color particles are attracted or repelled in response to a polarity of the at least one electrode. The data transmission box includes a control unit and a second pin. When the first pin of the electronic ink false nail patch is electrically connected with the second pin of the data transmission box, the electronic ink false nail patch receives an internal signal from the control unit of the data transmission box to control the polarity of the at least one electrode. The positively-charged first color particles and the negatively-charged second color particles within the plural micro capsules are moved in response to the polarity of the at least one electrode, so that the micro capsulation array layer exhibits a predetermined pattern.

In an embodiment, an electric field is generated between the transparent common electrode layer and the driving electrode layer, and the micro capsulation array layer is located within the electric field.

In an embodiment, each of the plural micro capsules further includes a transparent liquid, and the transparent liquid is accommodated within the transparent shell. The plural positively-charged first color particles and the plural negatively-charged second color particles are suspended in the transparent liquid.

In an embodiment, the plural micro capsules are in an array arrangement, and the plural electrodes are in an array arrangement. Moreover, one of the plural electrodes is located under one of the plural micro capsules, or two of the plural electrodes are located under one of the plural micro capsules.

In an embodiment, the positively-charged first color particles are black particles and the negatively-charged second color particles are white particles. Alternatively, the first color particles are white particles and the second color particles are black particles.

In an embodiment, the data transmission box includes a box body and at least one patch placement region. The second pin is formed on the patch placement region. The electronic ink false nail patch is placed on the at least one patch placement region. The first pin of the circuit board is electrically connected with the second pin of the data transmission box.

In an embodiment, the data transmission box further includes at least one protrusion post. The at least one patch placement region is formed on a top surface of the at least one protrusion post.

In an embodiment, the electronic ink false nail patch includes a first magnetic element, and the patch placement region comprises a second magnetic element. When the electronic ink false nail patch is placed on the corresponding patch placement region, the first magnetic element and the second magnetic element are magnetically attracted by each other.

In an embodiment, the data transmission box further includes a universal serial bus module, and the data transmission box receives an external signal from an external device through the universal serial bus module. After the external signal is converted into the internal signal by the control unit, the internal signal is transmitted to the electronic ink false nail patch to control the polarity of the at least one electrode of the circuit board.

In an embodiment, the data transmission box further includes a Bluetooth transmission module, and the data transmission box receives an external signal from an external device through the Bluetooth transmission module. After the external signal is converted into the internal signal by the control unit, the internal signal is transmitted to the electronic ink false nail patch to control the polarity of the at least one electrode of the circuit board.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating an electronic false nail device according to an embodiment of the present invention, in which an electronic ink false nail patch is separated from a data transmission box;

FIG. 2 is a schematic perspective view illustrating the electronic false nail device according to the embodiment of the present invention, in which the electronic ink false nail patch is placed into the data transmission box;

FIG. 3 is a schematic cross-sectional view illustrating a portion of the electronic ink false nail patch according to the embodiment of the present invention; and

FIG. 4 schematically illustrates the electronic ink false nail patch of the electronic false nail device attached on the user's finger according to an embodiment of the present invention.

### DETAILED DESCRIPTION OF THE PREFERRED EMBODIMENT

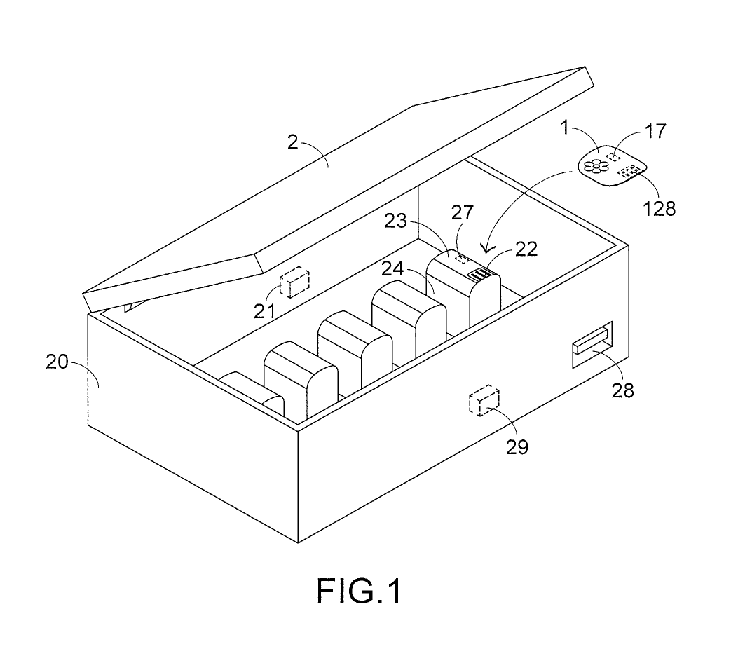

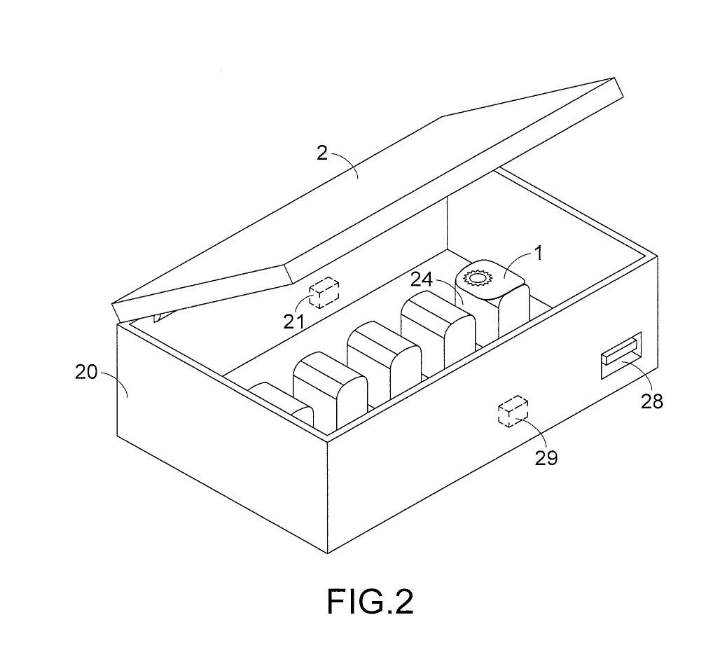

Please refer to FIGS. 1 and 2. FIG. 1 is a schematic perspective view illustrating an electronic false nail device according to an embodiment of the present invention, in which an electronic ink false nail patch is separated from a data transmission box. FIG. 2 is a schematic perspective view illustrating the electronic false nail device according to the embodiment of the present invention, in which the electronic ink false nail patch is placed into the data transmission box. As shown in FIGS. 1 and 2, the electronic false nail device comprises an electronic ink false nail patch 1 and a data transmission box 2. The electronic ink false nail patch 1 uses an electronic ink technology. According to the electronic ink technology, the electronic ink false nail patch 1 is connected with a power source only during the process of converting a pattern of the electronic ink false nail patch 1. Moreover, when the electronic ink false nail patch 1 is not connected with the power source, the pattern is still maintained on the electronic ink false nail patch 1.

The concepts of the present invention will be described as follows. According to the electronic ink technology, the displayed pattern is maintained when the electronic ink false nail patch 1 and the data transmission box 2 are separated from each other, i.e., the electronic ink false nail patch 1 is in a separated state (see FIG. 1). If the user is tired of seeing the original pattern after the electronic ink false nail patch 1 has been used for a certain time period, the user may place the electronic ink false nail patch 1 into the data transmission box 2 (see FIG. 2). After the electronic ink false nail patch 1 is electrically connected with the data transmission box 2, the electronic ink false nail patch 1 receives a signal from the data transmission box 2. Consequently, the displayed pattern of the electronic ink false nail patch 1 is changed. For example, the displayed pattern is a flower before the electronic ink false nail patch 1 is placed into the data transmission box 2 (see FIG. 1). After the electronic ink false nail patch 1 is placed into the data transmission box 2, the displayed pattern is changed to a sun (see FIG. 2).

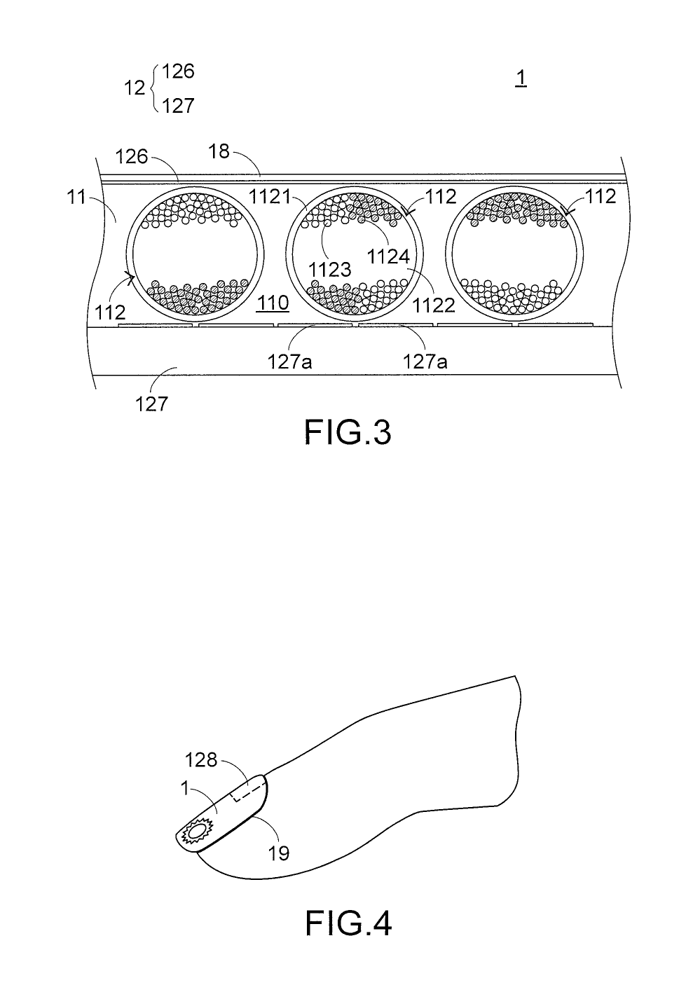

The structure of the electronic ink false nail patch 1 will be described in more details as follows. For succinctness, only a portion of the electronic ink false nail patch 1 is shown. FIG. 3 is a schematic cross-sectional view illustrating a portion of the electronic ink false nail patch according to the embodiment of the present invention. The electronic ink false nail patch 1 comprises a micro capsulation array layer 11 and a circuit board 12. The micro capsulation array layer 11 comprises a package structure 110 and plural micro capsules 112. The tiny micro capsules 112 are encapsulated within the transparent package structure 110. The size of the micro capsule 112 is approximately equal to the diameter of the human hair. Moreover, the micro capsules 112 are arranged in an array and distributed within the package structure 110. By changing the colors of the micro capsules 112, the micro capsulation array layer 11 exhibits a predetermined pattern.

A method for changing the colors of the micro capsules 112 will be described as follows. Each micro capsule 112 comprises a transparent shell 1121, a transparent liquid 1122, plural positively-charged first color particles 1123 and plural negatively-charged second color particles 1124. The transparent liquid 1122, the plural positively-charged first color particles 1123 and the plural negatively-charged second color particles 1124 are accommodated within the transparent shell 1121. The plural positively-charged first color particles 1123 and the plural negatively-charged second color particles 1124 are suspended in the transparent liquid 1122. In response to an electric field, the plural positively-charged first color particles 1123 and the plural negatively-charged second color particles 1124 are moved within the transparent shell 1121.

The circuit board 12 comprises a transparent common electrode layer 126 and a driving electrode layer 127. The driving electrode layer 127 comprises plural electrodes 127a. At least one electrode 127a is located under one corresponding micro capsule 112. The micro capsulation array layer 11 is arranged between the transparent common electrode layer 126 and the driving electrode layer 127. Moreover, an electric field is generated by the corresponding electrode 127a and the transparent common electrode layer 126. Due to the electric field, the positive charges and the negative charges in each micro capsule 112 are attracted or repelled to the corresponding positions. By changing the direction of the electric field, the positively-charged first color particles 1123 and the negatively-charged second color particles 1124 are controlled to be moved to the top side or the bottom side of the corresponding micro capsule 112. The colors of the color particles at the top side of the micro capsule 112 are exhibited. In such way, the purpose of switching the first color to the second color or switching the second color to the first color is achieved. In other words, by controlling the polarity of each electrode 127a, either the positively-charged first color particles 1123 or the negatively-charged second color particles 1124 are repelled and moved to the top side of the transparent shell 1121 according to the electrode 127a. Consequently, the predetermined color is exhibited. According to the positions and the color distribution of the micro capsules 112, the entire of the micro capsulation array layer 11 exhibits a predetermined patterned to be viewed by the user. For facilitating the user to wear the electronic ink false nail patch 1, an adhesive layer 19 is formed on a bottom surface of the circuit board 12 (see FIG. 4). Through the adhesive layer 19, the electronic ink false nail patch 1 can be attached onto the user's fingernail.

In an embodiment, the positively-charged first color particles 1123 are black particles, and the negatively-charged second color particles 1124 are white particles. In another embodiment, the positively-charged first color particles 1123 are white particles, and the negatively-charged second color particles 1124 are black particles. It is noted that the colors of these color particles are not restricted.

Moreover, the micro capsules 112 are in an array arrangement, and the electrodes 127a are also in the array arrangement. In an embodiment, there is a one-to-one relationship between the electrodes 127a and the micro capsules 112. That is, one electrode 127a is located under the corresponding micro capsule 112. Alternatively, there is a two-to-one relationship between the electrodes 127a and the micro capsules 112. That is, two electrodes 127a are located under the corresponding micro capsule 112. Hereinafter, the two-to-one relationship between the electrodes 127a and the micro capsules 112 will be taken as an example. Since two electrodes 127a are located under the corresponding micro capsule 112, a purpose of mixing the first color with the second color is achieved. For example, the positively-charged first color particles 1123 are black particles, and the negatively-charged second color particles 1124 are white particles. In case that the two electrodes 127a under the micro capsule 112 includes a positive electrode and a negative electrode, the top side of the micro capsule 112 exhibits a half of black color and a half of white color. Consequently, a gray color is sensed by the user.

In an embodiment, the transparent common electrode layer 126 is encapsulated within the package structure 110. In another embodiment, the transparent common electrode layer 126 is formed over the package structure 110 and a transparent resin layer 18 is formed over the transparent common electrode layer 126.

Please refer to FIGS. 1, 2 and 3. The data transmission box 2 comprises a box body 20 and at least one patch placement region 23. The electronic ink false nail patch 1 can be attached on the patch placement region 23. The electronic ink false nail patch 1 comprises a first pin 128. The patch placement region 23 of the data transmission box 2 comprises a second pin 22. When the electronic ink false nail patch 1 is placed on the patch placement region 23 of the data transmission box 2, the first pin 128 is electrically connected with the second pin 22. Consequently, the electronic ink false nail patch 1 acquires a small amount of electric power from the data transmission box 2. Meanwhile, the circuit board 12 generates an electric field to adjust the color of the micro capsules 112.

In an embodiment, the data transmission box 2 further comprises at least one protrusion post 24. The at least one patch placement region 23 is formed on the top surface of the at least one protrusion post 24. Due to the at least one protrusion post 24, the electronic ink false nail patch 1 can be placed on the corresponding patch placement region 23 more easily. In an embodiment, the electronic ink false nail patch 1 comprises a first magnetic element 17, and the patch placement region 23 comprises a second magnetic element 27. When the electronic ink false nail patch 1 can be placed on the corresponding patch placement region 23, the first magnetic element 17 and the second magnetic element 27 are magnetically attracted by each other. Consequently, the electronic ink false nail patch 1 can be attached on the corresponding patch placement region 23 more easily, and the electronic ink false nail patch 1 will not drop down.

The data transmission box 2 further comprises a control unit 21. The control unit 21 can convert an external signal into an internal signal. The internal signal is transmitted from the control unit 21 to the electronic ink false nail patch 1 through the second pin 22. The polarity of the electrode 127a of the circuit board 12 is controlled according to the internal signal.

In an embodiment, the data transmission box 2 further comprises a universal serial bus (USB) module 28. The data transmission box 2 receives the external signal from an external device through the USB module 28. After the external signal is converted into the internal signal by the control unit 21, the internal signal is transmitted to the electronic ink false nail patch 1. Consequently, the polarity of each of the electrodes 127a of the circuit board 12 can be controlled. In another embodiment, the data transmission box 2 further comprises a Bluetooth transmission module 29. The data transmission box 2 receives the external signal from an external device through the Bluetooth transmission module 29. After the external signal is converted into the internal signal by the control unit 21, the internal signal is transmitted to the electronic ink false nail patch 1. Consequently, the polarity of each of the electrodes 127a of the circuit board 12 can be controlled. An example of the external device includes but is not limited to a mobile phone or a computer.

FIG. 4 schematically illustrates the electronic ink false nail patch of the electronic false nail device attached on the user's finger according to an embodiment of the present invention. When the electronic ink false nail patch 1 is not connected with the power source, the pattern can be maintained for at least a certain time period. Consequently, the electronic ink false nail patch 1 can be used as a false fingernail. When the user wants to change the old pattern into a new pattern, the user may place the electronic ink false nail patch 1 into the data transmission box 2. Since the electronic ink false nail patch 1 is powered again, the pattern is changed in response to the generated electric field.

From the above descriptions, the present invention provides an electronic false nail device. According to the electronic ink technology, the same electronic ink false nail patch can be designed to have various patterns. Moreover, the electronic ink false nail patch can be reused. When the electronic ink false nail patch is worn on the user's fingernail, it is not necessary to provide electric power to the electronic ink false nail patch. Consequently, the user-friendliness of the electronic false nail device is largely enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An electronic false nail device, comprising:
an electronic ink false nail patch comprising:
a micro capsulation array layer comprising a package structure and plural micro capsules within the package structure, wherein each of the micro capsules comprises a transparent shell, plural positively-charged first color particles and plural negatively-charged second color particles, wherein the plural positively-charged first color particles and the plural negatively-charged second color particles are accommodated within the transparent shell and movable within the transparent shell; and
a circuit board comprising a transparent common electrode layer, a driving electrode layer and a first pin, wherein the driving electrode layer comprises plural electrodes, at least one electrode of the plural electrodes is located under one micro capsule of the plural micro capsules, and the plural positively-charged first color particles and the plural negatively-charged second color particles in each micro capsule are attracted or repelled in response to a polarity of the at least one electrode; and
a data transmission box comprising a control unit and a second pin,
wherein when the first pin of the electronic ink false nail patch is electrically connected with the second pin of the data transmission box, the electronic ink false nail patch receives an internal signal from the control unit of the data transmission box to control the polarity of the at least one electrode, wherein the positively-charged first color particles and the negatively-charged second color particles within the plural micro capsules are moved in response to the polarity of the at least one electrode, so that the micro capsulation array layer exhibits a predetermined pattern.

2. The electronic false nail device according to claim 1, wherein an electric field is generated between the transparent common electrode layer and the driving electrode layer, and the micro capsulation array layer is located within the electric field.

3. The electronic false nail device according to claim 2, wherein each of the plural micro capsules further comprises a transparent liquid, and the transparent liquid is accommodated within the transparent shell, wherein the plural positively-charged first color particles and the plural negatively-charged second color particles are suspended in the transparent liquid.

4. The electronic false nail device according to claim 3, wherein the plural micro capsules are in an array arrangement, and the plural electrodes are in an array arrangement, wherein one of the plural electrodes is located under one of the plural micro capsules, or two of the plural electrodes are located under one of the plural micro capsules.

5. The electronic false nail device according to claim 1, wherein the positively-charged first color particles are black particles and the negatively-charged second color particles are white particles; or the positively-charged first color particles are white particles and the negatively-charged second color particles are black particles.

6. The electronic false nail device according to claim 1, wherein the data transmission box comprises a box body and at least one patch placement region, wherein the second pin is formed on the patch placement region, the electronic ink false nail patch is placed on the at least one patch placement region, and the first pin of the circuit board is electrically connected with the second pin of the data transmission box.

7. The electronic false nail device according to claim 6, wherein the data transmission box further comprises at least one protrusion post, wherein the at least one patch placement region is formed on a top surface of the at least one protrusion post.

8. The electronic false nail device according to claim 6, wherein the electronic ink false nail patch comprises a first magnetic element, and the patch placement region comprises a second magnetic element, wherein when the electronic ink false nail patch is placed on the corresponding patch placement region, the first magnetic element and the second magnetic element are magnetically attracted by each other.

9. The electronic false nail device according to claim 1, wherein the data transmission box further comprises a universal serial bus module, and the data transmission box receives an external signal from an external device through the universal serial bus module, wherein after the external signal is converted into the internal signal by the control unit, the internal signal is transmitted to the electronic ink false nail patch to control the polarity of the at least one electrode of the circuit board.

10. The electronic false nail device according to claim 1, wherein the data transmission box further comprises a Bluetooth transmission module, and the data transmission box receives an external signal from an external device through the Bluetooth transmission module, wherein after the external signal is converted into the internal signal by the control unit, the internal signal is transmitted to the electronic ink false nail patch to control the polarity of the at least one electrode of the circuit board.
